(19) United States
(12) Patent Application Publication
(10) Pub. No.: US 2026/0106446 A1
(43) Pub. Date: Apr. 16, 2026

(54) CIRCUIT BREAKER

(71) Applicant: Ellenberger & Poensgen GmbH, Altdorf (DE)

(72) Inventors: Hendrik-Christian KOEPF, Nuernberg (DE); Alexander LABS, Winkelhaid (DE)

(73) Assignee: Ellenberger & Poensgen GmbH, Altdorf (DE)

(21) Appl. No.: 19/360,518

(22) Filed: Oct. 16, 2025

(30) Foreign Application Priority Data
Oct. 16, 2024 (DE) 10 2024 210 036.6

(51) Int. Cl. H02H 3/08

(52) U.S. Cl. CPC H02H 3/08

(57) ABSTRACT

A circuit breaker having two terminals, between which a current path is formed, to which a unit is assigned for the direction-dependent determination of an electric current carried via the current path. The current path has a first branch with two semiconductor switches electrically connected in series and opposite to each other, each comprising a control input and operated via a control unit corresponding to a time-current tripping characteristic. Via the time-current tripping characteristic, at least partially differing durations are given for different current strengths, from which the current path is interrupted, and wherein at least some of the durations differ for different current directions.

This nonprovisional application claims priority under 35 U.S.C. § 119(a) to German Patent Application No. 10 2024 210 036.6, which was filed in Germany on Oct. 16, 2024, and which is herein incorporated by reference.

### BACKGROUND OF THE INVENTION

### Field of the Invention

The present invention relates to a circuit breaker and the use of a circuit breaker. The circuit breaker has two terminals between which a current path is formed.

### Description of the Background Art

Industrial plants usually have several actuators by means of which workpieces are created and/or processed. The actuators themselves usually include an electric motor that is powered by an inverter. At least the actuators are usually operated by an electric current. For simplified interconnection, the individual actuators, especially the inverters, are connected in parallel to each other and fed by means of a common DC link. Usually, a DC voltage between 400 V and 650 V is carried by means of the DC link, and this is fed by means of a DC voltage source, such as a rectifier, which is connected to a supply network.

Since the actuators are operated differently, the amount of energy taken from the DC link is variable over time, which leads to fluctuations in the electrical voltage applied to the DC link. To ensure that the operation of the respective actuator is not affected by this, each inverter usually has an energy storage device in the form of a capacitor, which is used to stabilize the electrical voltage used.

To prevent further damage to the respective actuator or the surrounding area in the event of actuator failure, for example in the event of a short circuit of the electric motor or the inverter, for example due to a fire that occurs, each actuator is usually electrically connected to the DC link by means of a circuit breaker. The circuit breaker monitors the electric current carried to the respective actuator, and if it exceeds a certain threshold value, a switch of the circuit breaker is actuated so that the current flow to the actuator is interrupted.

In the event of a short circuit in one of the actuators, it is possible that the electrical current flowing to this actuator is not only provided by the DC voltage source, but that the energy storage of an actuator connected in parallel is also emptied. Due to the low-impedance terminal in the defective actuator, a comparatively large electric current flows from the energy storage of the actuator connected in parallel back into the DC link and from there to the defective actuator, at least until the defective actuator is electrically separated from the DC link. Until then, however, the increased electric current is fed from the energy storage device of the actuator connected in parallel into the DC link by means of the circuit breaker assigned to this actuator. Depending on the circuit breaker used, it is possible that due to the increased electrical current, the circuit breaker is actuated, so that the actuator connected in parallel is disconnected from the DC link, even though this actuator has not malfunctioned. This means that this actuator fails unnecessarily, which increases operating costs of the industrial plant.

A tube rectifier is known from US 2,693,566 A. To prevent damage to the tube, two diodes are connected in front of it antiparallel to each other and in series to the tube. In the diode connected opposite to the current flow direction to the tube, a resistor is electrically connected in series. In normal operation, the electrical voltage across the resistor is comparatively low. However, if a reverse current occurs due to a malfunction of the tube, an electrical voltage develops across the resistor, as a result of which a relay connected in parallel is actuated, which leads to the triggering of a switch connected in series to the tube.

CH 214 712 A provides an arrangement for the protection of DC grids against reverse current. A relay by means of which a switch is actuated is electrically connected in series with a diode. For this purpose, a resistor is connected in parallel. Thus, the relay was energized either at a desired current or at an undesired current, causing the switch to be actuated.

### SUMMARY OF THE INVENTION

It is therefore an object of the invention to specify a particularly suitable circuit breaker and a particularly suitable use of a circuit breaker, wherein advantageously the number of unnecessary triggers is reduced and/or operational safety is increased.

The circuit breaker is used, for example, to protect a device, and the circuit breaker is, for example, a device circuit breaker. Alternatively or in combination with this, the circuit breaker serves to protect a line and is therefore a line circuit breaker. At the very least, the circuit breaker is preferably suitable, in particular provided and set up, to be introduced into an electrical circuit and to interrupt the current flow across it in the event of a malfunction.

The circuit breaker comprises two terminals between which a current path is formed. In normal operation, an electric current is carried between the two terminals by means of the current path, so that in particular a load that is electrically connected to one of the terminals is energized. In this case, the circuit breaker is closed and therefore electrically conductive. In the open state, on the other hand, the circuit breaker is electrically non-conductive, and the current path is interrupted. At least there is no low-impedance terminal, and for example, the current path is galvanically isolated.

A unit for determining an electric current conducted by means of the current path is assigned to the current path. For example, the unit is a component of the current path or is arranged next to it, for example. In particular, it is possible to measure the conducted electrical current directly by means of the unit. Alternatively, this is determined, for example, from other measurement data, which in turn are appropriately measured by means of the unit. The determination of the conducted electrical current is direction-dependent. In other words, the unit is used to determine the amount of the electric current quantitatively, as well as qualitatively, that is in which direction the electric current flows. In summary, the amount of electric current is thus determined for each of the electricity bills. For this purpose, for example, the electric current is measured with a sign, wherein, for example, a positive sign is used for one current direction and a negative sign for the other current direction. At a minimum, the unit can be used to determine in which direction the electric current flows between the terminals, i.e., from which of the terminals to which.

The current path has a first branch with two semiconductor switches. These are electrically connected in series. Consequently, when the electric current flows between the two terminals, it is carried via the first branch and thus via both semiconductor switches. The semiconductor switches are connected in opposite directions to each other. As a result, it is possible to interrupt the electric current in both directions by means of the two semiconductor switches. Conveniently, each of the two semiconductor switches has a freewheeling diode, which simplifies the production of the semiconductor switches and thus reduces component costs.

For example, semiconductor switches are different from each other or are purposefully identical in design. Appropriately, a field-effect transistor is used as a semiconductor switch, preferably a MOSFET or a JFET. In another alternative, for example, an IGBT is used. Each of the switches has at least two outputs, for example a collector and an emitter. These are assigned to the current path, and for example, the collectors or the emitters of the two semiconductor switches are contacted with each other, so that, for example, it is a "common source" or a "common drain" terminal. The other outputs are routed against the terminals, for example directly or via other components. In addition, each semiconductor switch has a control input, which is referred to in particular as the base. Based on an electrical voltage applied to the control input, in particular the switching state of the respective semiconductor switch is determined, i.e., whether it is electrically conductive or electrically non-conductive.

The semiconductor switches are operated by means of a control unit. In particular, the control inputs of the semiconductor switches are connected to the control unit for this purpose. The control unit, for example, is constructed by means of discrete components and in particular has a number of different electrical components. Alternatively, the control unit includes, for example, at least electronic components, in particular a microcontroller. The control unit is conveniently signal-connected to the unit, so that the control unit in particular also records the conducted electric current. For example, the control unit determines the electric current depending on the direction, based on the measurement data provided by the unit. In other words, the evaluation of the measurement data is carried out by means of the control unit, and the measurement data is provided by means of the unit.

The semiconductor switches are operated by means of the control unit according to a time-current tripping characteristic, which is also known as the time-current curve. By means of the time-current tripping characteristic, at least partially differing durations are given for different current strengths. Consequently, the time-current tripping characteristic is a table, with a duration given for different current strengths. At least some of the durations vary with different current strengths. However, it is also possible that certain current strengths are assigned the same duration. However, at least two current strengths that have not disappeared, i.e., that do not amount to 0 A, are each assigned a duration, which differ. In particular, the current strength refers to the amount of electric current conducted.

Furthermore, some of the durations associated with the same current strength differ depending on the current direction. In other words, at least some of the durations for different current directions differ. In summary, the time-current tripping characteristic indicates at least two different current strengths for each current direction, for which the durations differ. The durations also differ in the different current directions, which is why there are at least four different durations.

If the electric current is carried at the appropriate current strength for the assigned duration, the current path is interrupted. For this purpose, the semiconductor switches are operated accordingly by means of the control unit, preferably controlled. In summary, if the electric current with the given current strength has been conducted for the assigned duration via the current path, the control unit appropriately controls the semiconductor switches in such a way that the current path is interrupted. In particular, the current strength is greater than a nominal current of the circuit breaker. In particular, at least one of the semiconductor switches is first opened, i.e., put into an electrically non-conductive state, so that the electric current comes to a standstill. It is possible that the same current strength is carried in one of the current directions for a longer duration than in the other current directions until the current path is interrupted.

Due to such the design of the circuit breaker, it is therefore possible to use it to specifically monitor it for a fault in a load powered by it, such as an actuator, in particular a short circuit in this load. In the event of a short circuit, the electric current is only conducted in one of the two current directions via the circuit breaker. If the electric current flows in the opposite direction, this is not caused by a short circuit at the load. In particular, in this case, the switch is not actuated. This makes it possible to adjust the time-current tripping characteristic for the respective load that is protected by the circuit breaker in such a way that overload or damage to the load is avoided. The current direction is directed towards the actuator.

In the opposite current direction, on the other hand, the time-current tripping characteristic is adjusted in such a way that damage to any DC link is avoided. It is expedient to enable a greater electric current flow from the load into the DC link or a supply network energizing the load or the like, without interrupting the current path. Thus, the actuator is still operational, especially since it does not malfunction. Alternatively or in combination with this, the circuit breaker is assigned to a battery, for example. By adjusting the time-current tripping characteristic, it is possible to allow a higher charging current than a discharging current without interrupting the current path.

In particular, the circuit breaker is used in a DC circuit, for example between a load and a DC link or the like. In particular, the time-current tripping characteristic for a current flow from the DC link to the load is adapted to the load used, so that in the event of a fault in the load, such as a short circuit, the current flow to the load is interrupted. In the opposite direction of the current flow, on the other hand, the time-current tripping characteristic in particular is adapted to the DC link or other components of the respective system in which the load is used, so that it is also protected.

Preferably, there is an electrical DC voltage between 400 V and 650 V in the DC circuit, i.e., in particular higher DC voltage. Preferably, the circuit breaker is used to protect an actuator in an industrial plant. The actuator forms the load in particular. Due to the reduced number of unnecessary triggering events, i.e., activation of the circuit breaker, namely interrupting the current path, the number of failures is reduced, which reduces operating costs. The circuit breaker is expediently used in the field of industrial automation. In particular, the electrical voltage switched by means of the circuit breaker is 24 V, 48 V, 380 V, 650 V, 760 V. In an alternative, the circuit breaker is used to protect street lighting, ship electrical systems, railway applications-infrastructure, railway applications-propulsion or in the field of electrified aviation. In another alternative, the circuit breaker is used in the expansion and integration of renewable energy producers, in island grids, in the private domestic sector, in greenhouses, in the electrification of road-based mobility (electromobility), agriculture or in construction site vehicles. The electrical (direct) voltage used is, for example, between 1500 V and 3000 V or is 110 V, 380 V, 400 V 800 V, 1000 V 1500 V, 3000 V. In summary, as an alternative to the application in an industrial plant, the circuit breaker is used, for example, in an electric vehicle, an airplane or a ship/boat.

Due to the two semiconductor switches, for example, switching capacity is increased, and for example, the two semiconductor switches are designed in such a way that the electric current flow in both directions can be interrupted by means of either of them. Alternatively, each only allows the electric current to be interrupted in one of the two current directions. Since the two semiconductor switches are connected opposite to each other, it is still possible to interrupt the electric current flow via the first branch by means of both semiconductor switches. For example, the semiconductor switches differ, especially depending on the maximum switchable electrical circuit. Thus, it is possible, for example, to use a semiconductor switch with a comparatively high breaking capacity for a predominant operation in one of the current directions and a semiconductor switch with a lower switching capacity for the other current direction, at least if the time-current tripping characteristic is adjusted accordingly. As a result, manufacturing costs are reduced. However, it is particularly preferred when the two semiconductor switches are identical. Thus, identical parts can be used. Also, when installing the circuit breaker, with the exception of the adjustment of the time-current tripping characteristic, no special installation position needs to be observed.

The unit preferably has a sensor, such as a current sensor. This is used, for example, to detect a magnetic field surrounding the current path, in particular by means of a Hall sensor, and on the basis of this, for example,, the electric current carried is determined. This is possible without contact, so that galvanic isolation in particular is realized. However, the unit is particularly preferred to include a shunt. This includes a measuring resistor, wherein the electrical voltage falling across the shunt is measured to determine the electric current carried. This reduces manufacturing costs.

For example, the sensors of the unit are each designed in such a way that they can be used to measure/record the current flow in both current directions. Alternatively, the unit has two sub-units, which are electrically connected in series, in particular. Here, one of the sub-units enables the determination of the electric current in one current direction and the other sub-units the determination of the electric current in the other current direction. This reduces the demands on the respective sensor, which is why the unit can be designed comparatively inexpensively, even if two sub-units are required.

For example, the two semiconductor switches are operated separately by means of the control unit. In this way, it is possible, for example, to allow for a return current in a targeted manner, or to operate the semiconductor switches in a certain chronological order. However, it is particularly preferred if the control inputs of the semiconductor switches are electrically short-circuited, i.e., electrically contacted to each other with low impedance. This ensures that both semiconductor switches are always operated at the same time and have the same switching state, i.e., are open or closed. Also, when the semiconductor switches are opened, the electric current flow along the current path comes to a complete standstill. Therefore, an electric current flow in the opposite current direction is also not possible if the electric current has been routed in one of the current directions with a certain current strength for the assigned duration. Furthermore, due to the short circuit, the electrical circuit is simplified.

For example, the current path comprises only the first branch and is formed in particular by means of it. However, it is particularly preferable that a second branch is electrically connected in parallel with the first branch. The second branch also comprises two semiconductor switches electrically connected in series and opposite to each other, each of which has a control input and is also operated by means of the control unit. The two semiconductor switches of the second branch are also conveniently operated using the same time-current tripping characteristic. Due to the second branch, the electric current carried by each of the semiconductor switches is reduced, which is why comparatively inexpensive semiconductor switches can be used. For example, the semiconductor switches of the second branch are different from each other or expediently identical in construction. Preferably, the semiconductor switches of the second branch are identical in construction to the semiconductor switches of the first branch. This means that identical parts can be used, and storage is simplified during production. In particular, the first and second branches are structurally identical to each other, i.e., preferably (point) symmetrical. As a result, the electric current is evenly distributed between the two branches, which is why excessive stress on one of the two branches is impossible.

For example, the control inputs of the two semiconductor switches of the second branch are electrically short-circuited. This means that the semiconductor switches of the second branch are always operated at the same time. For example, the semiconductor switches of the first branch and the second branch can be operated independently of each other. Thus, it is possible to allow the electric current via one of the two branches, and not via the other. However, it is particularly preferable that the control input of one of the two semiconductor switches of the first branch and the control input of one of the two semiconductor switches of the second branch are electrically shorted. This means that they are also always switched at the same time, which simplifies electrical interconnection. In particular, the control inputs of those semiconductor switches that are assigned to the same current direction are electrically shorted, which is why the electric current flow in the corresponding current direction can always be completely interrupted.

Particularly preferably, all control inputs are electrically short-circuited. As a result, all semiconductor switches are always operated in the same way, for example they are set to either the electrically conductive or electrically non-conductive state. In this way, electrical wiring is simplified and the susceptibility to errors is reduced. In addition, this always ensures that if the current strength of the electric current in the current directions is greater than the assigned duration and thus the current path is interrupted, no return current occurs, i.e., no electric current in the opposite current direction. Thus, for example, in the event of a defect in the actuator protected by the circuit breaker, the actuator is completely de-energized, increasing safety.

For example, the unit is assigned to an area of the current path separate from the branches, which is why the complete electric current can be safely detected by means of it. Alternatively, the unit is assigned to only one of the two branches. In this case, the two branches, especially with the exception of the unit, are preferably identical in construction or at least have the same electrical resistance. As a result, the electric current is divided equally between the two branches, and the electric current determined by the unit is half of the electric current carried by the current path. The unit is particularly preferentially comprised of the two sub-units, wherein by means of each sub-unit only the electric current directed in one of the current directions can be determined, in particular measured/recorded. For example, the two sub-units are assigned to one of the two branches. Preferably, however, each of the branches is assigned one of the sub-units, which are in particular antiparallel to each other, so that the electric current is determined in both directions, i.e., its half can always be recorded in each case. In particular, the two branches are thus antiparallel or point-symmetrical to each other. Thus, the electric current carried by each sub-unit is comparatively low. The two branches are also identical in construction but have different orientations. This means that they can be provided as a module, which reduces manufacturing costs.

For example, the complete circuit breaker is free of mechanical switches. Particularly preferred, however, a mechanical switch is electrically connected in series with the first branch. If the second branch is also present, it is also electrically connected in series with the mechanical switch. The mechanical switch is preferably a component of a relay that includes a drive. Preferably, the relay, i.e., the drive, is operated by means of the control unit. Due to the mechanical switch, it is possible to galvanically isolate the two terminals from each other, which improves safety. Conveniently, the control unit first interrupts an electric current flow by means of the semiconductor switches and then the mechanical switch is opened, which is done arc-free. When switching to the electrically conductive state, however, it is advisable to first set the mechanical switch and then the semiconductor switches to the electrically conductive state. Thus, an electric arc is also avoided there. Preferably, the control unit is designed accordingly. For example, the mechanical switch includes a single moving contact or, conveniently, a double contact, which reduces the electrical voltage switched by each contact, increasing the required arc voltage.

A circuit breaker with two terminals between which a current path is formed is used to protect a load in a DC circuit. The circuit breaker has a unit for the direction-dependent determination of an electric current carried by means of the current path, which is assigned to the current path. The current path has a first branch with two semiconductor switches electrically connected in series and opposite to each other, each comprising a control input and operated by means of a control unit corresponding to a time-current tripping characteristic. By means of the time-current tripping characteristic, at least partially differing durations are given for different current strengths, from which the current path is interrupted, wherein at least some of the durations differ for different current directions.

Conveniently, the DC circuit comprises several such loads, which are electrically connected in parallel to each other, in particular. Due to the circuit breakers, it is thus avoided that in the event of a short circuit one of the loads, the circuit breakers assigned to the other loads, are actuated. In particular, the invention also relates to such a DC circuit, which is in particular a component of an industrial plant. In this case, the load or some of the loads form an actuator, which is used, for example, to process and/or create a workpiece.

The further developments and advantages explained in connection with the circuit breaker are also to be transferred mutatis mutandis to the use / the DC circuit as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a DC circuit with two loads, each of which is assigned a circuit breaker,

FIG. 2 schematically simplified, a circuit diagram of the circuit breaker, and

FIG. 3 schematically shows, a time-current tripping characteristic.

### DETAILED DESCRIPTION

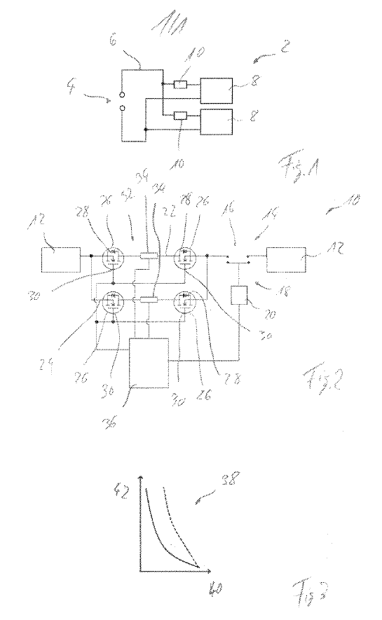

FIG. 1 schematically simplifies a DC circuit 2, which comprises a DC voltage source 4. By means of this, an electrical DC voltage of 650 V is provided, and by means of this a DC link 6 is powered. By means of this, two loads 8 are supplied, which are connected in parallel with each other and routed against the DC link 6 via a circuit breaker 10 each, which are identical in construction.

FIG. 2 shows a schematically simplified circuit diagram of the circuit breaker 10. The circuit breaker 10 has two terminals 12, between which a current path 14 is formed. One of the terminals 12 is routed against the DC link 6 and the other against the respective assigned load 8. The current path 14 has a mechanical switch 16, which is designed as a relay 18. This has a drive 20 by means of which the mechanical switch 16 is driven, which is designed as a double-pole breaker or a double-contact.

Furthermore, the current path 14 has a first branch 22 and a second branch 24, each of which is electrically connected in series to the mechanical switch 16. The first branch 22 and the second branch 24 are identical in construction and electrically connected in parallel. The two branches 22, 24 are arranged antiparallel to each other. In other words, one of the two branches 22, 24 is rotated by 180° with respect to the other branch 22, 24.

Each branch 22, 24 has two identical semiconductor switches 26, which are designed as MOSFETs. Thus, each semiconductor switch 26 has a freewheeling diode 28. The semiconductor switches 26 of each branch 22, 24 are electrically connected in series and opposite to each other, so that the blocking directions of the respective assigned freewheeling diodes 28 are arranged opposite to each other. In the variant shown, the collectors ("drain") of the semiconductor switches 26 of each branch 22, 24 are facing each other, so that it is a "common drain" circuit. The semiconductor switches 26 of each branch 22, 24 in the emitter ("source") of each branch 22, 24 are routed against one of the terminals 12 or the mechanical switch 26. Thus, the emitters of the semiconductor switches 26 of the first branch 22 are also electrically connected to the emitter of one of the semiconductor switches 26 of the second branch 24.

Each semiconductor switch 26 also has a control input 30 (base, "gate"), all of which are electrically contacted to each other. All control inputs 30 are electrically short-circuited. Consequently, the control inputs 30 of the two semiconductor switches 26 of each branch 20, 24 are electrically shorted, and in each case the control input 30 of one of the two semiconductor switches 26 of the first branch 22 and the control input 30 of one of the two semiconductor switches 26 of the second branch 24 are electrically shorted. In summary, the current path 14 thus comprises the first branch 22 and the second branch 24, which are connected in parallel with each other, and which each have the assigned two semiconductor switches 26, which are electrically connected in series and opposite to each other.

The circuit breaker 10 also has a unit 32 for the direction-dependent determination of the electric current carried by means of the current path 14, which is assigned to the current path 14. The unit 32 has two identical sub-units 34, which are assigned to the different branches 22, 24. Since the two branches 22, 24 are identical, the electric current carried by means of the current path 14 is symmetrically divided between both branches 22, 44.

The sub-units 34 have a shunt that includes a measuring resistor that is introduced into the respective branch 22, 24. In addition, each sub-unit 34 comprises an operational amplifier by means of which the electrical voltage generated by the respective measuring resistor can be measured. Based on the electrical voltage and the known ohmic resistance of the measuring resistor, it is possible to determine the electric current. The wiring of the operational amplifier is such that only one polarity of the electrical voltage can be measured. In the case of an opposite polarity, which corresponds to an opposite current flow, measurement is not possible. As a result, manufacturing costs are comparatively low.

Since the two branches 22, 24 are arranged antiparallel to each other, the current directions for which the electric current can be determined by means of the respective sub-unit 34 are also different. Thus, by means of unit 32, the electric current carried can be determined direction-dependent by means of the current path 14, which corresponds to twice the electric current determined by means of those sub-units 34 at which the measured electrical voltage is different from 0 V. If the electrical voltage is 0 V for both sub-units 34, the electric current conducted by the current path 14 is 0 A.

In an unspecified variant, each of the sub-units 34 has a current sensor, which can also only be used to determine the current carried in one of the current directions.

In summary, the unit 32 has the two sub-units 34, by means of which only the electric current carried in the current direction can be determined, with each branch 22, 24 being assigned to one of the sub-units 34. The two sub-units 34 are arranged antiparallel to each other.

The electric current is determined by means of a control unit 36, which is connected to each of the sub-units 34 by signal. By means of the control unit 36, the applicable electrical voltage is thus read out and, on the basis of the known ohmic resistance, the electric current conducted by means of the respective branch 22, 44 is determined and doubled. Thus, the control unit 36 has the knowledge of how high the electric current is, which is carried by means of the current path 14, and in which direction the electric current flows.

The control unit 36 has an unspecified microcontroller and is also connected to the drive 20, which is why the relay 18 is operated by the control unit 36. Also, the short-circuited control inputs 30 of all semiconductor switches 26 are connected to the control unit 36 by means of signals, so that all semiconductor switches 26 are operated by means of the control unit 36. In this process, all semiconductor switches 26 are set to either the electrically conductive or the electrically non-conductive state by means of the control unit 36.

The semiconductor switches 26 are operated by means of the control unit 36 according to a time-current tripping characteristic 38 shown in FIG. 3. In the graph, a current strength 40 is plotted on the x-axis and a duration 42 on the y-axis in a double logarithmic representation. The current strength 40 is always positive and thus the amount of an electric current.

The time-current tripping characteristic 38 has two branches, each of which is hyperbolic at least in sections, and which differ at least in sections. Thus, by means of the time-current tripping characteristic 38, each current strength 40 that is greater than a nominal current strength of the circuit breaker 10 is assigned at least one or two durations 42, which then differ. Here, one of the branches of the time-current tripping characteristic 38 is assigned to the electric current in one current direction and the other branch to the electric current in the other current direction via the current path 14. Thus, at least some of the durations 42 differ for different current directions, and for some of the current strengths 40. For a branch, for example, the duration 42 of 20 ms is assigned to the current strength 40, which corresponds to twice the nominal current strength, and the duration 42 of 10 ms is assigned to the current strength 40, which corresponds to four times the nominal current strength. In the case of the other branch, the duration 42 of 1 s is then assigned to the current strength 40, which corresponds to twice the nominal current strength, and the duration 42 of 100 ms to the current strength 40, which corresponds to four times the nominal current strength.

If the electric current has been conducted by means of the current path 14 with the duration 42 assigned to the respective current strength 40, i.e., if the corresponding duration 42 is reached, the current path 14 is interrupted. For this purpose, the semiconductor switches 26 are set to the electrically non-conductive state. After that, the relay 18 is operated, so that mechanical switch 16 is opened. As a result, the two terminals 12 are galvanically isolated from each other.

In normal operation, i.e., when the load 8 is energized in the desired way, the electric current flows from the DC link 6 via the electrically conductive circuit breaker 10 to the load 8. If the load 8 is working properly, the current strength 40 is equal to the rated current strength or less. However, if there is a load 8 failure, for example a short circuit, the current strength 40 increases comparatively strongly, which is determined by the unit 32. If this continues for the allocated duration 42, the circuit breaker 10 is set to the electrically non-conductive state, for which the semiconductor switches 26 and relay 18 are controlled accordingly.

However, until the circuit breaker 10 is set to the electrically non-conductive state, a low-impedance terminal is present at the load 8, which has the short circuit, which is also referred to as the defective load 8 in the following. As a result, it is possible that an electric current flow from a capacitor or other energy storage device of the still functioning load 8 to the defective load 8 also begins. Thus, by means of the circuit breaker 10 assigned to the functioning load 8, a comparatively high electric current is also conducted, although the load 8 does not malfunction. However, the current direction is opposite to the current direction in normal operation.

The branch of the time-current tripping characteristic 38 assigned to this current direction is chosen in such a way that the semiconductor switches 26 continue to remain in the electrically conductive state. Thus, after the defective load 8 has been disconnected from the DC link 6 by means of the assigned circuit breaker 10, operation of the functional load 8 is still possible. In summary, each circuit breaker 10 is used to protect the respective load 8 in the DC circuit of one of the loads 8 in the DC circuit 2.

The invention is not limited to the embodiment described above. Rather, other variants of the invention can also be derived from this by the skilled person without departing from the subject-matter of the invention. In particular, all the individual features described in connection with the embodiment can also be combined with each other in other ways without departing from the subject-matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit breaker comprising:
two terminals, between which a current path is formed;
a unit assigned to the current path for a direction-dependent determination of an electric current carried via the current path; and
a first branch comprising two semiconductor switches electrically connected in series and opposite to each other, the two semiconductor switches comprising a control input and being operated via a control unit corresponding to a time-current tripping characteristic via which at least partially differing durations are given for different current strengths, from which the current path is interrupted,
wherein at least some of the durations differ for different current directions.

2. The circuit breaker according to claim 1, wherein the control inputs of the two semiconductor switches are electrically short-circuited.

3. The circuit breaker according to claim 1, wherein a second branch is electrically connected parallel to the first branch, which has two semiconductor switches electrically connected in series and opposite to each other, each of which has a control input and is operated via the control unit.

4. The circuit breaker according to claim 3, wherein the control input of one of the two semiconductor switches of the first branch and the control input of one of the two semiconductor switches of the second branch are electrically short-circuited.

5. The circuit breaker according to claim 4, wherein all control inputs are electrically short-circuited.

6. The circuit breaker according to claim 3, wherein the unit has two sub-units, each of which are only used to determine the current carried in one of the current directions, and wherein one of the sub-units is assigned to each branch.

7. The circuit breaker according to claim 1, wherein a mechanical switch is electrically connected in series with the first branch.

8. The circuit breaker according to claim 1, wherein the circuit break protects a load in a DC circuit.
